(19) United States
(12) Patent Application Publication
(10) Pub. No.: US 2025/0363576 A1
(43) Pub. Date: Nov. 27, 2025

(54) BUILDING A KNOWLEDGE STRUCTURE TO VISUALIZE MASTERY OF A USER ON VARIOUS EDUCATIONAL CONCEPTS

(71) Applicant: 2hr Learning, Inc., Austin, TX (US)

(72) Inventors: Samy Aboel-Nil, Austin, TX (US); Bogdan Tenea, Bucharest (RO); Simon Said, Malta (MA)

(73) Assignee: 2hr Learning, Inc., Austin, TX (US)

(21) Appl. No.: 19/215,325

(22) Filed: May 22, 2025

Related U.S. Application Data
(60) Provisional application No. 63/651,224, filed on May 23, 2024.

(51) Int. Cl. G06Q 50/20

(52) U.S. Cl. CPC G06Q 50/205

(57) ABSTRACT

A system and method for transforming a computer display into a dynamic knowledge structure representing hierarchical knowledge levels, achievements, and prerequisites that represent foundational knowledge to mastery of a knowledge concept is disclosed. The system and method access a knowledge data that defines knowledge levels. The knowledge levels represent a sequence of knowledge levels to reach mastery levels. An electronic display is transformed to visually present the knowledge levels as interconnected, physical object representations. The interconnections represent the prerequisite knowledge levels. Then personnel knowledge completion levels of a student are accessed. The appearances of the knowledge level physical objects that correspond to respective knowledge levels to be differentiated based on a state of mastery of corresponding knowledge levels by the student that inform the student of progress towards knowledge concept mastery and gaps in the foundational knowledge of the student of the knowledge concept mastery.

### CROSS-REFERENCE TO RELATED APPLICATION

This application claims the benefit under 35 U.S.C. § 119 (e) and 37 C.F.R. § 1.78 of U.S. Provisional Application No. 63/651,224, filed May 23, 2024, which is incorporated by reference in its entirety.

### FIELD OF THE INVENTION

The present invention relates in general to the field of electronics, and more specifically to a hierarchical knowledge foundation, visualization, and tracking system and method that transforms a user interface into a mastery level depiction of a user mastery of knowledge units as a knowledge structure, where the knowledge structure is made up of various joined shapes representing knowledge.

### BACKGROUND OF THE INVENTION

Educational platforms have undergone numerous transformations to track the progress of learners. The educational platforms provide text, audio, and video-based lessons for learners to learn virtually at their own pace and convenience. Moreover, the educational platforms offer different types of questions in assessments to practice. The incorporation of different interactive features within an educational platform enhances the engagement of the learners.

Historically the educational platform has relied on different metrics such as progress bars, points, in-game currency, or badges to indicate the progress of the learners. These indicators provide a visual representation of the learner's progress within a particular domain, primarily focusing on task completion rather than providing a meaningful connection with learning objectives.

Consequently, the learners may complete a lesson without completely covering all the fundamental topics of that lesson. The traditional educational platforms may help learners master a concept but still fail to help them understand thoroughly the concepts behind the questions answered incorrectly. The students might attempt the questions, however, the understanding behind the concepts may still seem very superficial thus creating a knowledge gap.

### SUMMARY

A method for transforming a computer display into a dynamic knowledge structure representing hierarchical knowledge levels, achievements, and prerequisites that represent foundational knowledge to mastery of a knowledge concept includes executing code to cause a computer system to perform operations that includes accessing knowledge data that defines knowledge levels that represent a sequence of knowledge levels to reach mastery levels. The method also includes transforming an electronic display to visually present the knowledge levels as interconnected, physical object representations, wherein the interconnections represent the prerequisite knowledge levels. The method includes accessing personnel knowledge completion levels of a student. The method also includes causing appearances of the knowledge level physical objects that correspond to respective knowledge levels to be differentiated based on a state of mastery of corresponding knowledge levels by the student that inform the student of progress towards knowledge concept mastery and gaps in the foundational knowledge of the student of the knowledge concept mastery.

A system for transforming a computer display into a dynamic knowledge structure representing hierarchical knowledge levels, achievements, and prerequisites that represent foundational knowledge to mastery of a knowledge concept includes one or more processors; and a memory, coupled to the one or more processors, having code stored therein that when executed by the one or more processors causes the one or more processors to perform operations. The operation includes accessing knowledge data that defines knowledge levels that represent a sequence of knowledge levels to reach mastery levels. The system also includes transforming an electronic display to visually present the knowledge levels as interconnected, physical object representations, wherein the interconnections represent the prerequisite knowledge levels. The system includes accessing personnel knowledge completion levels of a student. The system also includes causing appearances of the knowledge level physical objects that correspond to respective knowledge levels to be differentiated based on a state of mastery of corresponding knowledge levels by the student that inform the student of progress towards knowledge concept mastery and gaps in the foundational knowledge of the student of the knowledge concept mastery.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary hierarchical knowledge foundation, visualization, and tracking system environment.

FIG. 2 depicts an exemplary hierarchical knowledge foundation, visualization, and tracking system environment process using the hierarchical knowledge foundation, visualization, and tracking system of FIG. 1.

FIG. 3 depicts a flow diagram of visualizing the knowledge structure.

FIG. 4 depicts a flow diagram of initiating the knowledge graph.

FIG. 5 depicts an exemplary implementation of the hierarchical knowledge foundation, visualization, and tracking system environment.

FIGS. 6-8 depicts an exemplary view of the user interface of a hierarchical knowledge foundation, visualization, and tracking system.

FIG. 9 depicts an exemplary network environment in which the hierarchical knowledge foundation, visualization, and tracking system environment of FIG. 1 and the hierarchical knowledge foundation, visualization, and tracking process of FIG. 2 may be practiced.

FIG. 10 depicts an exemplary computer system.

### DETAILED DESCRIPTION

A hierarchical knowledge foundation, visualization, and tracking system provides access to a knowledge structure that aids in visualizing the mastery level of a user on various educational concepts. The system transforms a computer display into a dynamic knowledge structure representing hierarchical knowledge levels, achievements, and prerequisites that represent foundational knowledge to mastery of a knowledge concept. The knowledge structure is made up of various interconnected, physical object representations, such as blocks, that each represent an individual educational concept (hereinafter may also be referred to as ‘concept’). The knowledge structure allows a user to visualize mastery of foundational knowledge that leads to mastery of various concepts. In at least one embodiment, the user selects a starting block from the knowledge structure, representing an educational concept. To facilitate a personalized learning experience, the hierarchical knowledge foundation, visualization, and tracking system continuously updates user's mastery level on educational concepts in real-time based on the user's progress on attaining mastery on the corresponding concepts. The hierarchical knowledge foundation, visualization, and tracking system may also allow access to resources and learning material that aid in attaining mastery on various concepts by the user. As the user interacts with the hierarchical knowledge foundation, visualization, and tracking system, the user may have to answer various types of questions such that answering them correct aid in attaining mastery on the associated concept. Based on the response of user to these questions, the hierarchical knowledge foundation, visualization, and tracking system updates the user's mastery, which is then visualized in the knowledge structure.

In at least one embodiment, the hierarchical knowledge foundation, visualization, and tracking system provides questions aligned with one or more curriculum standards relevant to a knowledge level of a student, such as grade of the student, a particular educational certification, or other educational level. The hierarchical knowledge foundation, visualization, and tracking system can further include gamification elements to enhance the user's learning experience. As the user demonstrates mastery over educational concepts, the user earns rewards such as points, badges. The rewards serve as motivational tools, encouraging continuous interaction and sustained effort. By integrating the gamification elements, the hierarchical knowledge foundation, visualization, and tracking system not only supports learning but also makes it enjoyable and engaging.

Furthermore, the knowledge structure and the hierarchical knowledge foundation, visualization, and tracking system allow structured exploration of interconnected educational concepts, ensuring that the user builds a solid foundation on a lower level concepts that are foundational before learning advanced or higher level concepts. Moreover, the real-time updates on user performance enable adaptive learning, providing immediate feedback and tailored support. The hierarchical knowledge foundation, visualization, and tracking system stores data including user details, questions, responses, and mastery levels associated with the user in a database.

In at least one embodiment, the hierarchical knowledge foundation, visualization, and tracking system utilizes an artificial (AI) engine to create a dynamic, personalized, and engaging knowledge structure. The AI engine tracks progress, personalize learning experiences, and adapt dynamically to the needs of each user. Further details related to use of AI engine for visualization of mastery of the user on various concepts will be explored in subsequent sections.

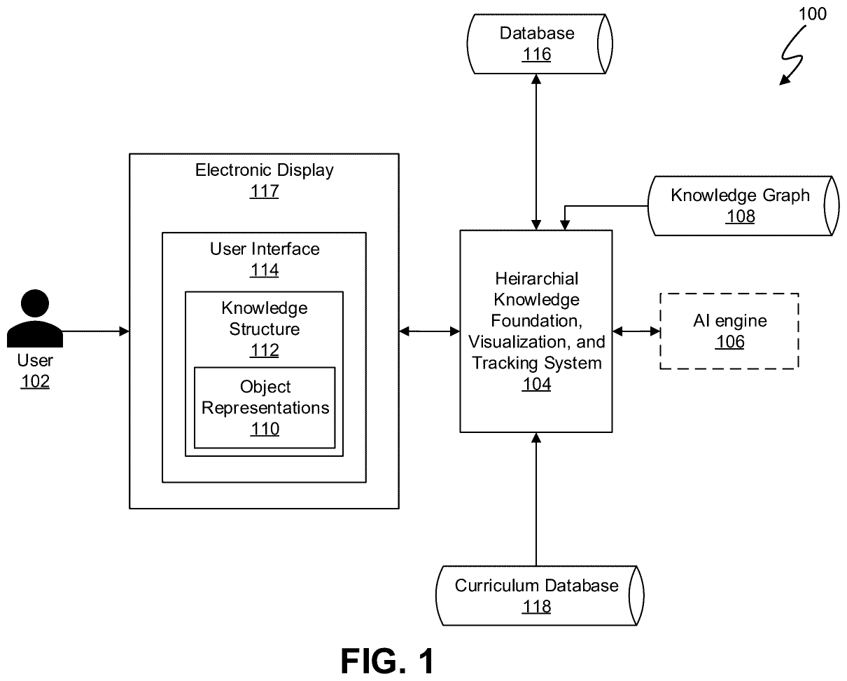

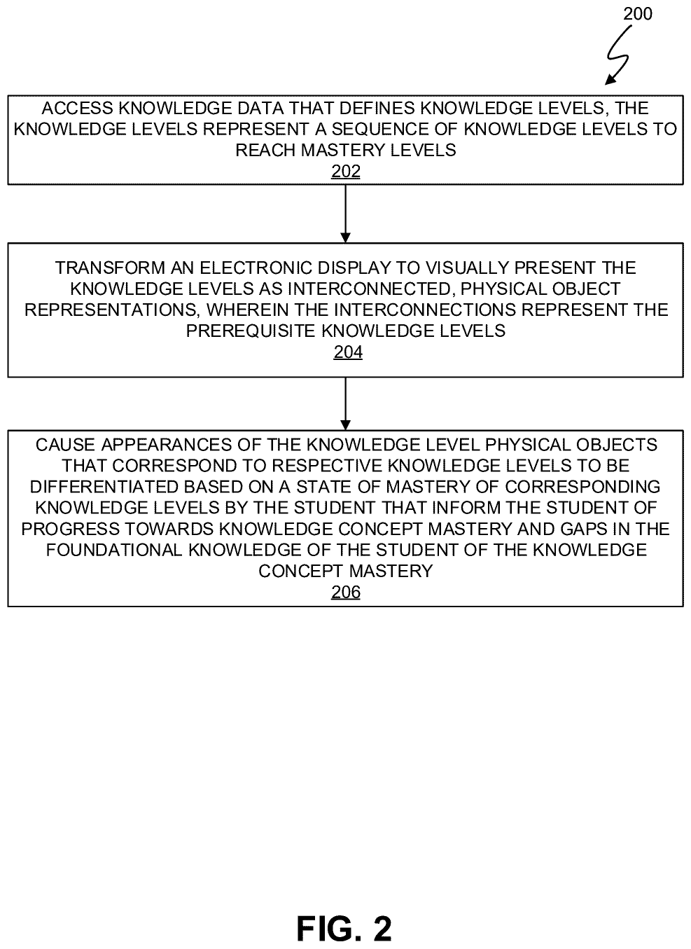

FIG. 1 depicts an exemplary hierarchical knowledge foundation, visualization, and tracking system environment 100. FIG. 2 depicts an exemplary hierarchical knowledge foundation, visualization, and tracking system environment process 200 utilized by the hierarchical knowledge foundation, visualization, and tracking system environment 100.

The hierarchical knowledge foundation, visualization, and tracking system environment 100 refers to a digital space where a user 102 interacts and engages with a hierarchical knowledge foundation, visualization, and tracking system 104 through the internet. The user is a student, a learner, or any person using the hierarchical knowledge foundation, visualization, and tracking system 104. The hierarchical knowledge foundation, visualization, and tracking system environment 100 encompasses the hierarchical knowledge foundation, visualization, and tracking system 104 that facilitates real-time communication and engagement with the user 102.

Referring to FIGS. 1 and 2, in operation 202, the hierarchical knowledge foundation, visualization, and tracking system 104 accesses knowledge data that defines knowledge levels, wherein the knowledge levels represent a sequence of knowledge levels to reach mastery levels from a knowledge graph 108 located in either a local or remote memory. Each mastery level represents a state of completion of learning resources required to master each educational concept by the user 102. The knowledge graph 108 maps out the connections between the educational concepts and mastery level, allowing for the visualization of the knowledge structure 112. In other words, the knowledge graph 108 is a curriculum graph that defines prerequisite relationships between educational concepts. Each educational concept represents the fundamental units of knowledge within the domain. The educational concepts include the plurality of subject wherein each subject comprises plurality of topic, subtopics. Moreover, each topic and subtopics includes a plurality of questions displayed to the user 102 on a user interface 114 of the hierarchical knowledge foundation, visualization, and tracking system 104. Furthermore, the knowledge graph 108 accurately reflects the curriculum standards by ensuring that each educational concept within the knowledge graph 108 corresponds precisely to the topics and learning objectives outlined in the education standards. The knowledge graph 108 allows mapping of curriculum standards to ensure that the educational standards, key concepts, and their interdependencies are correctly represented. Each prerequisite relationship is defined in alignment with the curriculum standards, ensuring that the educational concepts are linked to topics as required by the educational standards. Additionally, the knowledge graph 108 should be dynamic and adaptable, allowing for updates and modifications to reflect any changes in the curriculum over time.

The knowledge graph 108 allows to identify a mastery level of the user 102 and associate the mastery level with each of the interconnected, physical object representations 110 within the knowledge structure 112. Each knowledge level object representation 110 visually represents knowledge levels as interconnected, physical object representations, such as blocks or any other physical 2-dimensional or 3-dimensional shape. Interconnections between object representations 110 represent prerequisite knowledge levels. For example, object representations of addition, subtraction, multiplication, division, fractions, and order of operations are non-exclusive, exemplary knowledge levels represented by the object representations 110 and are prerequisites for the knowledge concept of algebra. Typically, each of the object representations 110 refers to an educational concept represented within the knowledge structure 112. The mastery level describes whether the user 102 knows about a specific educational concept or not on hierarchical knowledge foundation, visualization, and tracking system 104. the mastery level on each educational concept can be represented as mastered or not mastered states or learned, learning, and unknown states such that ‘learned state’ represents successful completion of resources required to master the corresponding educational concept, ‘learning state’ represents that the user 102 is currently pursuing the resources and yet to master the educational concept, and the ‘unknown state’ represents that status of mastery for a corresponding educational concept is unknown. The knowledge graph 108 is configured to identify the mastery level to determine the mastery of the user on a certain educational concept.

In at least one embodiment, the knowledge graph 108 is built as a truth table involves structuring in a tabular format where each row represents mastery level and each column denotes Boolean values indicating the presence or absence of the corresponding knowledge of the educational concept. The knowledge graph 108 for a clear and systematic representation of the connections between the mastery level and educational concept. The use of a truth table format in constructing the knowledge graph 108 facilitates efficient querying, reasoning, and allowing easy update, quick access and manipulation of the relationships between different entities within the knowledge graph 108. In at least one embodiment, the knowledge graph 108 iteratively tests and validates to identify any gaps or inaccuracies in the prerequisite relationships and allows for adjustments to be made. Moreover, the knowledge graph 108 evolves over time as new knowledge is acquired and as the understanding of prerequisite relationships deepens. The dynamic nature allows knowledge graph 108 to remain relevant and up-to-date, accommodating changes in the educational concepts.

Typically, the mapping of the educational concept of the user 102 onto the knowledge graph 108 involves aligning the mastery level of the user 102. For example, the user 102 quiz score on a particular educational concept can be mapped to the knowledge graph 108, providing insights into the mastery level of the user 102 on the specific educational concept. The knowledge structure 112 can be a 3D model used to visualize the learning progress and mastery level attained on various educational concepts by the user 102. Each knowledge level object representation 110 in the knowledge structure 112 represents a specific concept from the plurality of concepts, and the state of each knowledge level object representation 110 indicates the level of mastery on that concept. The mastery levels can be shown in three different states-learned, unlearned, and unknown state, where the learned state indicates that user has mastered the educational concept, the learning state represents progress of learning an educational concept, and unknown state represents that certain educational concept is not started by the user 102. In at least one embodiment, the hierarchical knowledge foundation, visualization, and tracking system 104 allows the user 102 to master advanced educational concepts even before mastery of foundational educational concepts.

In operation 204, the hierarchical knowledge foundation, visualization, and tracking system 104 transforms an electronic display 117 to visually present the knowledge levels as interconnected, physical object representations, wherein the interconnections represent the prerequisite knowledge levels and represents the mastery level of the user 102 on each educational concept as block in the knowledge structure 112. The knowledge structure is made up of a plurality of blocks each representing an individual educational concept. The knowledge structure 112 comprises the plurality of object representations with each knowledge level object representation 110 representing educational concepts. Typically, there is a prerequisite relationship that exists between each knowledge level object representation 110 of knowledge structure 112, specifying which educational concept must be understood or mastered before others can be fully comprehended. The hierarchical structuring is utilized herein for education and training, where the user 102 builds on foundational knowledge to grasp more advanced topics effectively. For example, in the knowledge graph 108 for mathematics, understanding basic arithmetic operations would be a prerequisite for learning algebra, which in turn is required before studying calculus.

The system causes the mastery level state of the educational concepts to update, such as in real-time, based on the user response provided by the user 102 corresponding to a displayed question on the user interface 114 of the hierarchical knowledge foundation, visualization, and tracking system 104. The plurality of questions include multiple-choice questions, fill-in-the-blanks, or interactive problem-solving tasks. As the user 102 responds to the plurality of questions, the hierarchical knowledge foundation, visualization, and tracking system 104 analyzes the answers in real-time. This analysis involves checking the correctness of the responses and also considering the time taken to answer. Based on the data, the hierarchical knowledge foundation, visualization, and tracking system 104 evaluates the level of mastery of the user 102 for the specific concept. In at least one embodiment, the hierarchical knowledge foundation, visualization, and tracking system 104 can adjust the difficulty level of subsequent questions, provide additional practice on weaker areas, or even suggest supplementary resources such as tutorials or explanatory videos. For example, if the user 102 shows difficulty with fractions, the hierarchical knowledge foundation, visualization, and tracking system 104 displays more fraction-related problems. As the user 102 demonstrates mastery level over educational concepts, the hierarchical knowledge foundation, visualization, and tracking system 104 allows to earn rewards such as points or badges. The rewards serve as motivational tools, encouraging continuous interaction and sustained effort from the user 102.

In at least one embodiment, the knowledge data accessed by the hierarchical knowledge foundation, visualization, and tracking system 104 is stored in a curriculum database 118, such as common core curriculum standards, that align to educational standards and a plurality of knowledge testing questions within the educational standards. The curriculum database 118 includes a plurality of topics and corresponding topic details that are mapped into the knowledge graph 108. The hierarchical knowledge foundation, visualization, and tracking system 104 relies on the curriculum database 118, containing structured information about one or more educational standards. The one or more educational standards are the board of education, school committee or school board that determines the educational policy in a city, county, state, or province. The curriculum database 118 comprises a detailed listing of the topics that the user 102 is expected to learn at different grade levels. The curriculum database 118 is utilized to generate the plurality of questions. Typically, the plurality of questions is generated based upon the curriculum database 118 which can be utilized in the hierarchical knowledge foundation, visualization, and tracking system 104. The curriculum database 118 is aligned to one or more educational standards including Common Core State Standards (CCSS), Next Generation Science Standards (NGSS), College Board, and so on which houses comprehensive details of each topic included in these curriculum.

The personnel knowledge completion levels of a student, such as user 102, are accessed. The personnel knowledge completion levels aimed to determine the completeness and accuracy of the student's understanding of a specific concept. The determined personnel knowledge completion levels are utilized by the hierarchical knowledge foundation, visualization, and tracking system 104 to generate a visual representation of the knowledge structure 112.

In operation 206, the hierarchical knowledge foundation, visualization, and tracking system 104 generates a visual representation of the knowledge structure 112 based on the knowledge graph 108 on the electronic display 117 and causes appearances of the knowledge level physical objects representation 110 that correspond to respective knowledge levels to be differentiated based on a state of mastery of corresponding knowledge levels by the student that inform the student of progress towards knowledge concept mastery and gaps in the foundational knowledge of the student of the knowledge concept mastery. The plurality of blocks are arranged hierarchically with a lower set of knowledge level physical objects representation 110 serving as prerequisites for a higher set of knowledge level physical objects representation 110. Notably, each knowledge level physical object representation 110 in the knowledge structure 112 corresponds to a specific educational concept, the knowledge level physical objects representation 110 are arranged hierarchically to reflect the current mastery level of the user 102 with the lower set of knowledge level physical objects representation 110 serving as prerequisites for the higher set of knowledge level physical objects representation 110. The visual representation aims to provide a clear and comprehensive overview of the current mastery level of the user 102 highlighting both their achievements and areas needing improvement. Typically, the mastery level is mapped onto the knowledge graph 108 that the visual represents on to the knowledge structure 112. Mastering the lower set of prerequisite knowledge levels represented by the physical objects representation 110 provides a solid foundation upon which more complex educational concepts can be understood and integrated.

The knowledge structure 112 is designed to be both informative and visually engaging, making it easier for the user 102 to comprehend their learning journey. Each knowledge level object representation 110 in the knowledge structure 112 represents a specific educational concept, and the blocks are arranged in a hierarchical manner. Foundational concepts are placed at the lower set of blocks of the knowledge structure 112, serving as the base upon which the higher set of blocks is built. This arrangement reflects the logical and pedagogical structure, ensuring that the user 102 can see the progression of their knowledge from basic to advanced levels. The visual representation of each knowledge level object representation 110 includes detailed information about the corresponding educational concept. The information typically includes the name of the educational concept, description of the educational concept, and the user's performance data related to the educational concept, such as quiz scores and assignment grades. Notably, color-coding or other visual cues are used to indicate the mastery level of the user 102 for each knowledge level object representation 110. The blocks might be represented as a solid wooden block for the learned state, the learning state is represented as a colored block, and the unknown state is represented as a transparent block. The visual cues provide immediate feedback to the user 102, helping them quickly identify which areas require further attention.

The knowledge structure 112 is selectable, e.g. clickable, and selecting, e.g. clicking, on the knowledge level object representation 110 shows the associated educational concept that needs to be successfully completed to change the state of the block, wherein clicking the block also provides a link to one or more resources to be completed by the user to attain mastery in the associated educational concept. The user 102 is able to click on or hover over each knowledge level object representation 110 to access more detailed information about their performance on the educational concepts, enabling user 102 to easily access the quizzes or assessments to improve their understanding of specific educational concepts. The hierarchical arrangement of each knowledge level object representation 110 is determined by the prerequisite relationships identified in the knowledge graph 108. Each knowledge level object representation 110 is positioned above the blocks representing its prerequisites, creating a clear visual hierarchy. For example, in mathematics, basic arithmetic might form the lower block, with algebra built upon it, followed by geometry, and then calculus at the higher blocks. In at least one embodiment, the knowledge structure 112 can be represented as a tower, a pyramid, or any suitable structure where blocks are aligned to show the inter-dependency of prerequisite educational concepts. In a tower, each block relies on the stability of the blocks beneath it, emphasizing the importance of a solid foundation. In addition, the knowledge structure 112 represents the educational concept, state of the blocks represent mastery level of the user 102 on the related concept, and order of the blocks represent inter-dependency of concepts such that the higher set of blocks are dependent on the lower set of blocks.

The representation of the knowledge level object representation 110 is a matter of design choice. For example, indicating mastery of educational concepts by solid wooden blocks and representing knowledge gaps by making blocks transparent within the knowledge structure 112. The knowledge structure 112 uses visual cues to denote levels of completion of mastery. The visual cues not only highlights areas of completion of mastery in a particular educational concept but also helps in identifying gaps in knowledge. The filling of the knowledge level object representation 110 can be achieved using solid colors or textures, with variations such as shading or patterns. Moreover, the transparent block indicates the knowledge gap, showing that the user 102 has not yet achieved mastery of the educational concept as a certain educational concept has not been attempted by the user 102. The transparent block can be visualized in various ways, such as using lighter shades, or outlines making it distinct from filled blocks.

Each interaction with the block within the knowledge structure 112 fills the knowledge level object representation 110. When the user skips the certain educational concept, the block is displayed as a transparent block. This dynamic updating ensures that the knowledge structure 112 remains an accurate and real-time representation mastery level of the user 102. For example, if the user 102 successfully completes a series of quizzes on algebra, the blocks corresponding to algebra concepts would transition from transparent to filled, demonstrating mastery. In addition to filled and transparent blocks, the knowledge structure 112 incorporates additional visual cues to enhance understanding of the user 102 to track current status of mastery on the knowledge structure 112. The educational concept for which the mastery is in progress can be visualized as the colored block for the user to identify that he/she is working on that educational concept. This interaction allows the user 102 to take a proactive role in their education journey, understanding precisely the educational concepts that need attention. Furthermore, the knowledge structure 112 is designed to track progress over time to allow the user 102 to see and fill any knowledge gaps. The knowledge structure 112 provides a visual representation to monitor the progress of individual user 102 on various concepts and to identify concepts where the use is facing any difficulty.

In at least one embodiment, the hierarchical knowledge foundation, visualization, and tracking system 104 utilizes a prompt. The prompt is generated to guide an Artificial Intelligence (AI) engine 106 to render the visualization of the knowledge structure 112 to reflect the mastery level of the user 102 on various educational concepts. Typically, the AI engine 106 gathers the user's mastery level. The mastery level provides quantifiable measures of the understanding and mastery of various educational concepts of the user 102. Further, the mastery level is mapped onto the knowledge graph 108. Once the mastery level is mapped onto the knowledge graph 108, the AI algorithms are employed. The AI engine 106 considers various factors, such as the user 102 performance on individual educational concepts, the prerequisite relationships between educational concepts. This helps in determining the mastery level of the user 102 for each educational concept for visualizing the knowledge structure 112.

The AI engine 106 uses data mining, machine learning, and statistical analysis techniques. The data mining techniques help in extracting useful patterns and insights from the mastery level, such as identifying common errors or frequently misunderstood educational concepts. The machine learning models can predict future performance trends based on historical data to anticipate potential knowledge gaps. The statistical analysis ensures that the mastery level is accurately interpreted, accounting for variations and anomalies that might skew the results. After processing the mastery level to generate the knowledge graph 108, the prompt for the AI engine 106 is generated. The prompt is a detailed set of instructions that guides the AI engine 106 in rendering the visualization of the knowledge structure 112. The prompt includes information on the structure and layout of the knowledge structure 112 and the visual representation of each knowledge level object representation 110. The structure and layout of the knowledge structure 112 are determined by the hierarchical arrangement of the educational concepts in the knowledge graph 108. The prompt specifies how the educational concepts are visually represented, with foundational educational concepts forming the lower block of the knowledge structure 112 and more advanced educational concepts building upon them. Each knowledge level object representation 110 in the knowledge structure 112 corresponds to a specific educational concept and includes details such as the educational concept name, description, and the mastery level of the user 102.

To indicate mastery of educational concepts, the prompt includes instructions on how to fill the blocks. The filled block signifies that the user has achieved mastery on the corresponding educational concepts, based on predefined criteria such as achieving a threshold score or consistent demonstration of understanding. The prompt specifies the use of solid wooden blocks, transparent block, or colored block, with variations indicating different levels of proficiency. For example, solid wooden blocks indicate complete mastery, while a colored block indicates partial understanding of the concept and transparent blocks indicate the user has not started learning that educational concept. Conversely, the prompt instructs the AI engine 106 on how to represent knowledge gaps by making blocks transparent, when the user does not attempt the educational concept. Typically, the transparency is visualized using lighter shades or outlines, making it distinct from mastered blocks. Moreover, the AI engine 106 is configured to dynamically update the visualization based on the ongoing performance data of the user 102. As the user 102 completes new assessments and demonstrates improved understanding on concepts, the knowledge structure 112 should be updated to reflect current mastery level on those concepts. This real-time feedback loop is essential in keeping the visualization relevant.

Furthermore, transferring the prompt to the AI engine 106 to build the knowledge structure 112 based on the mastery level of the user 102 on various educational concepts. The AI engine 106 is configured to build the knowledge structure 112. As the user 102 completes and masters a new educational concept the knowledge structure 112 evolves to reflect the current mastery level accurately. This real-time construction of the knowledge tower 112 keeps the user 102 informed about their progress, motivating them to continue engaging with the hierarchical knowledge foundation, visualization, and tracking system 104. In at least one embodiment, the visual representation of the knowledge structure 112 may use animations to highlight changes in the knowledge structure 112, such as when a block transitions from transparent to solid wooden blocks after the educational concept is mastered. These visual elements help maintain the user 102 interest and make the knowledge structure 112 an attractive and motivating tool.

In at least one embodiment, the gamification element is utilized within the hierarchical knowledge foundation, visualization, and tracking system 104 to provide rewards and recognition to motivate the user 102 on completion of the mastery of a particular educational concept. As the user 102 masters new concepts, thereby earning rewards, which can be represented in various forms such as badges, points, or virtual trophies. The rewards are visually displayed on the knowledge structure 112, providing a sense of accomplishment. Moreover, the gamification element also includes challenges and quests that can be incorporated into the knowledge structure 112. The challenges can be designed to progressively increase in difficulty, helping the user 102 to build their educational concepts and confidence incrementally. Successfully completing the challenges fills the corresponding blocks in the knowledge structure 112, visibly marking the user 102 progress.

In operation 205, the hierarchical knowledge foundation, visualization, and tracking system 104 is communicatively coupled to a database 116 for accessing knowledge data that defines student knowledge levels, wherein the knowledge levels represent a sequence of knowledge levels to reach mastery levels. In at least one embodiment, in operation 205 the hierarchical knowledge foundation, visualization, and tracking system 104 accesses and stores user details for individual users, state of mastery on educational concepts of each user, and interaction of the user with the knowledge structure 112. The database 116 includes detailed user information, including personal details and progress records of the user 102. The database 116 stores the plurality of questions that the hierarchical knowledge foundation, visualization, and tracking system 104 displays to the user 102, ensuring a diverse and comprehensive set of challenges. Moreover, the user responses to the questions are also stored in the database 116, allowing to track performance of the user. Additionally, the database 116 maintains records of mastery on educational concepts of each user, dynamically updating the mastery level based on the performance of the user on various quizzes and learning resources related to each concept.

In at least one embodiment, the hierarchical knowledge foundation, visualization, and tracking system environment 100 includes features such as voice chat, text chat, leaderboards, and social networking elements. The hierarchical knowledge foundation, visualization, and tracking system environment 100 aims to create immersive, interactive experiences, fostering a sense of entertainment while providing educational content to the user 102. The hierarchical knowledge foundation, visualization, and tracking system environment 100 includes Artificial Intelligence (AI) engine 106 configured to analyze data related to learning history of the user 102. This data-driven approach enables the AI engine 106 to gain insights into the profile of the user 102, including age, grade, and the topic selected by the user on the hierarchical knowledge foundation, visualization, and tracking system 104. Typically, the AI engine 106 can identify patterns of the learning behavior of the user 102 to tailor the content creation process. In the hierarchical knowledge foundation, visualization, and tracking system environment 100, the AI engine 106 plays a crucial role by analyzing the user details to suggest relevant content that aligns with the interests of the user 102. Additionally, natural language processing (NLP) is employed to evaluate the written responses provided by users in quizzes and assignments while using the hierarchical knowledge foundation, visualization, and tracking system 104.

Typically, performance data specific to the user 102 is accessed, which includes scores from quizzes and assignments undertaken using the hierarchical knowledge foundation, visualization, and tracking system 104. The performance data allows the AI engine 106 to understand the progress, educational concept level, and engagement of the user 102 in the hierarchical knowledge foundation, visualization, and tracking system 104. For example, quizzes and assignments are often designed to challenge the knowledge and abilities of the user 102, providing a structured way to measure learning and improvement over time. By accurately recording and analyzing the scores, the hierarchical knowledge foundation, visualization, and tracking system 104 can gain valuable insights into how the user 102 interacts with the hierarchical knowledge foundation, visualization, and tracking system 104, identifying strengths, weaknesses, and areas that may require additional support or adjustment.

The hierarchical knowledge foundation, visualization, and tracking system 104 is also configured to update the user profile based on the collected performance data. The user profile on the hierarchical knowledge foundation, visualization, and tracking system 104 contains a range of information, from personal details to in-depth records of the user's mastery history and achievements. By continuously updating the user profile with new data received from quizzes and assignments attempted by the user 102, the hierarchical knowledge foundation, visualization, and tracking system 104 ensures that the user's profile remains current and reflective of their latest activities and accomplishments performed on the hierarchical knowledge foundation, visualization, and tracking system 104. The dynamic updating process is essential for maintaining an accurate representation of the user's progress, which can be used to personalize the learning experience. For example, if the user 102 consistently excels in certain types of quizzes or assignments, the hierarchical knowledge foundation, visualization, and tracking system 104 recommends more challenging content that align with the demonstrated educational concepts. Conversely, if the user 102 struggles in specific areas, the hierarchical knowledge foundation, visualization, and tracking system 104 can offer additional resources, hints to help the user 102 to improve.

By employing AI engine 106, the hierarchical knowledge foundation, visualization, and tracking system 104 can deliver real-time updates and personalized recommendations, enhancing the overall learning experience of the user 102. Moreover, the use of natural language processing (NLP) allows the hierarchical knowledge foundation, visualization, and tracking system 104 to interpret and assess written responses in quizzes and assignments, providing a deeper understanding of the cognitive and linguistic abilities of the user 102. In at least one embodiment, accessing and updating the user details also protects data to safeguard personal information of the user 102. The hierarchical knowledge foundation, visualization, and tracking system 104 implements robust security measures, such as encryption and secure authentication protocols, to prevent unauthorized access and ensure that user data is handled responsibly. The iterative process allows the hierarchical knowledge foundation, visualization, and tracking system 104 to offer a personalized experience that adapts to the changing needs and preferences of the user 102. For example, as the user 102 progresses and improves their educational concepts, the hierarchical knowledge foundation, visualization, and tracking system 104 can introduce complex educational concepts to keep the user 102 engaged.

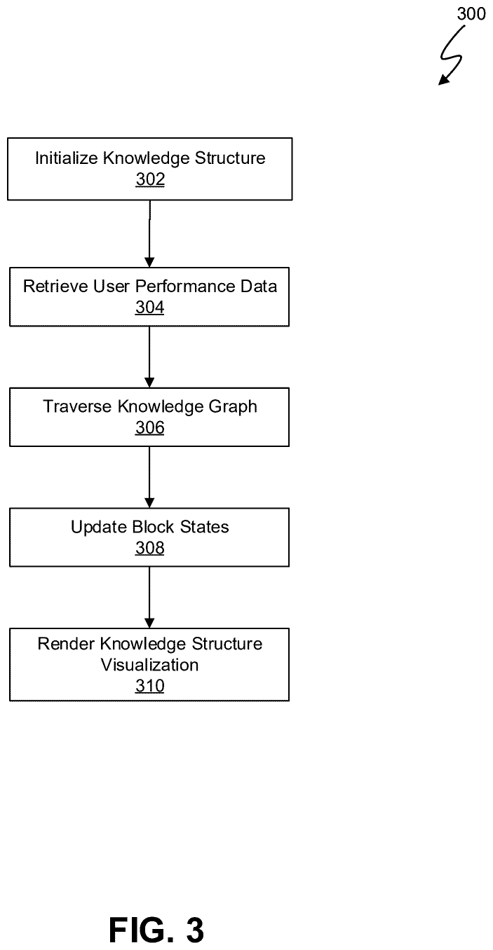

FIG. 3 depicts a flow diagram of visualizing the knowledge structure 112. As shown, at step 302 initialize the knowledge structure 112. Typically, the knowledge structure 112 is conceptualized as a hierarchical, multi-layered structure where each knowledge level object representation 110 represents a specific educational concept. Herein, the knowledge structure 112 is in its initial state, with all blocks set to a default status, such as transparent, indicating that no mastery has been achieved yet on any concept. The initialization involves defining the blocks, their relationships with the educational concept, and the overall layout of the knowledge structure 112. The knowledge structure 112 is informed by the underlying knowledge graph 108, which maps the prerequisite relationship between the educational concept and level of mastery attained on those concepts. The knowledge structure 112 is then ready to be populated with data that will transform it into a dynamic representation of the user's 102 mastery level on various concepts. Once the knowledge structure 112 is initialized, at step 304, user's performance data is retrieved. The performance data helps in understanding the user's 102 current level of mastery in the educational concept. The performance data is collected from various sources, including quizzes or assignments conducted either on the hierarchical knowledge foundation, visualization, and tracking system 104 or a third-party learning platform. The performance data typically includes scores, completion rates, time spent on tasks, and so on.

After retrieving the user performance data, at step 306, the hierarchical knowledge foundation, visualization, and tracking system 104 updates the knowledge level object representation 110 states 306 in accordance with the user's 102 mastery of the corresponding knowledge level. the knowledge graph 108 is prepared based on the performance data. The knowledge graph 108 is a structured representation of the mastery level on the educational concepts. Traversing the knowledge graph 108 involves mapping of the mastery level of the user 102 onto the knowledge graph 108, which involves aligning the collected performance metrics with educational concepts within the knowledge graph 108. The alignment enables to contextualize the user performance within the specific educational concept.

After creating the knowledge graph, at step 308, the state of each block is updated in the knowledge structure 112. Each knowledge level object representation 110 in the knowledge structure 112 corresponds to a specific educational concept, and its state reflects the user's mastery on that educational concept. Based on the knowledge graph 108, the state of each knowledge level object representation 110 is updated. Typically, each filled knowledge level object representation 110 represents that the user 102 has mastered the corresponding educational concept, while those representing concepts with knowledge gaps remain transparent. The visual differentiation is essential for providing a clear and intuitive understanding of the user's 102 learning progress on the concepts. The visual representation ensures that the knowledge structure 112 accurately reflects the mastery level of the user 102.

Below is a summary of how the hierarchical knowledge foundation, visualization, and tracking system 104 Emphasizes the importance of foundational knowledge in the learning process:
Processing Steps:
   Input(s): Student performance data on foundational topics.
   Source(s) of input(s): Learning apps or educational platforms.
   Output(s): Visual cues in the knowledge tower indicating gaps in foundational knowledge.
   Process of converting the input(s) into output(s):
      Process Background and Setup: The system identifies foundational concepts within the knowledge graph.
      Define Operations used: Data analysis, visualization update.
      Algorithms used: Identify gaps in foundational knowledge by identifying non-mastered prerequisites and update the visualization accordingly.
      Hardware modules: Servers for data analysis, client devices for displaying the visualization.
      Relevant Data Models: Knowledge graph model, student knowledge stack model.
      Variables and Definitions: knowledge graph 108 (structure representing the curriculum) and database 116 (data on student's mastery of topics)
      Constraints: Accurate identification of foundational knowledge gaps, i.e. unmastered prerequisites.
      Settings: visualization settings (e.g. how many steps or grades forward or backward to compute from a selected object representation 110)

Encourages students to focus on mastering fundamental concepts
class StudentSkillStack:
   def_init_(self):
      self.topics={ }
   def add_topic(self, topic_id, known):
      self.topics[topic_id]=known
   def get_topic_status(self, topic_id):
      return self.topics.get(topic_id, False)

After updating the block states, at step 310, the knowledge structure 112 is rendered for visualization. The visual representation of the knowledge structure 112 is updated. The knowledge structure 112 is both interactive and user-friendly. The knowledge structure 112 is displayed hierarchically, with foundational educational concepts represented as lower set of blocks and more advanced educational concepts building upon them as upper set of blocks. Filled blocks are visually distinct from transparent blocks, making it easy to identify mastered concepts and the concepts that are still under learning progress. Different colored blocks such as red colored blocks represent the mastery is in progress. Interactive features are integrated into the visualization, allowing the user 102 to click on or hover over blocks to access detailed information about each concept.

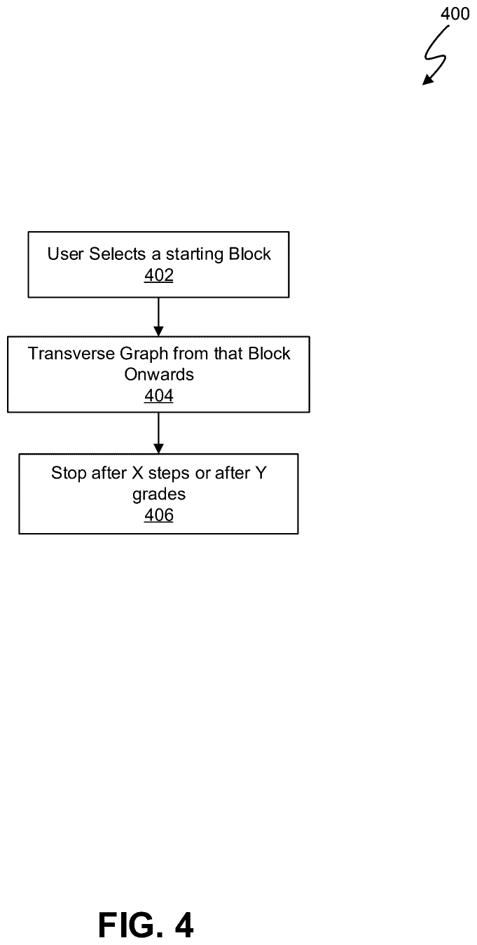

FIG. 4 depicts a flow diagram of initiating the knowledge graph 108. At step 402, the user 102 selects a starting block depicting the object representations 110 from the knowledge structure 112. The block represents a specific concept and serves as the initial point of starting. The user interface 114 provides a visual representation of the knowledge structure 112, allowing the user 102 to see and choose from various blocks. Once the starting block is selected, at step 404, the traversal process begins. This involves navigating through the knowledge graph 108 for the chosen block. The knowledge graph 108 maps out the connections between the educational concepts and the mastery level, allowing for the visualization of relationships and dependencies that exist within a particular domain. The knowledge graph 108 accurately reflects the curriculum standards by ensuring that the selected concept within the knowledge graph 108 corresponds precisely to the topics and learning objectives outlined in the education standards to allow mapping curriculum standards.

Next, at step 406, the traversal process stops after a specific number of steps (X steps). Another stopping criterion is stopping after reaching a certain grade level (Y grades). For example, if the user is studying at the 6th-grade level, the traversal might stop at the end of 7th grade, highlighting the progression and dependencies within this given grade.

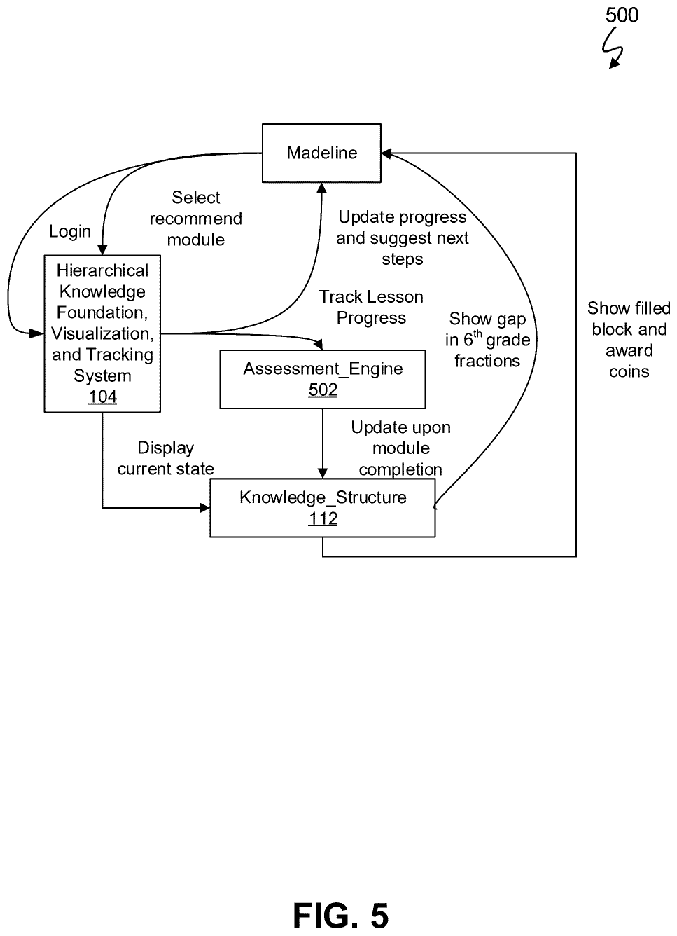

FIG. 5 depicts an exemplary implementation 500 of the online gaming environment 100. As shown, a user named “Madeline,” a 7th-grade student, is using the hierarchical knowledge foundation, visualization, and tracking system 104 to learn mathematics. She has just completed a unit on fractions but struggled with some related educational concepts in the previous grade. As Madeline logs into the hierarchical knowledge foundation, visualization, and tracking system 104, the knowledge structure 112 associated with Madeline's profile shows a gap in the 6th-grade section for fractions. The hierarchical knowledge foundation, visualization, and tracking system 104 recommends Madeline to revisit these educational concepts to fill the gap. Madeline selects the recommended module as indicated by the hierarchical knowledge foundation, visualization, and tracking system 104. The hierarchical knowledge foundation, visualization, and tracking system 104 displays the lessons and quizzes. As she works through the lessons and quizzes, the assessment engine 502 evaluates her responses and updates her performance data. Upon successfully completing the module, the previously unfilled block on her knowledge structure 112 is now filled, and she earns coins for her achievement. The hierarchical knowledge foundation, visualization, and tracking system 104 updates her progress and suggests the next steps in her learning journey.

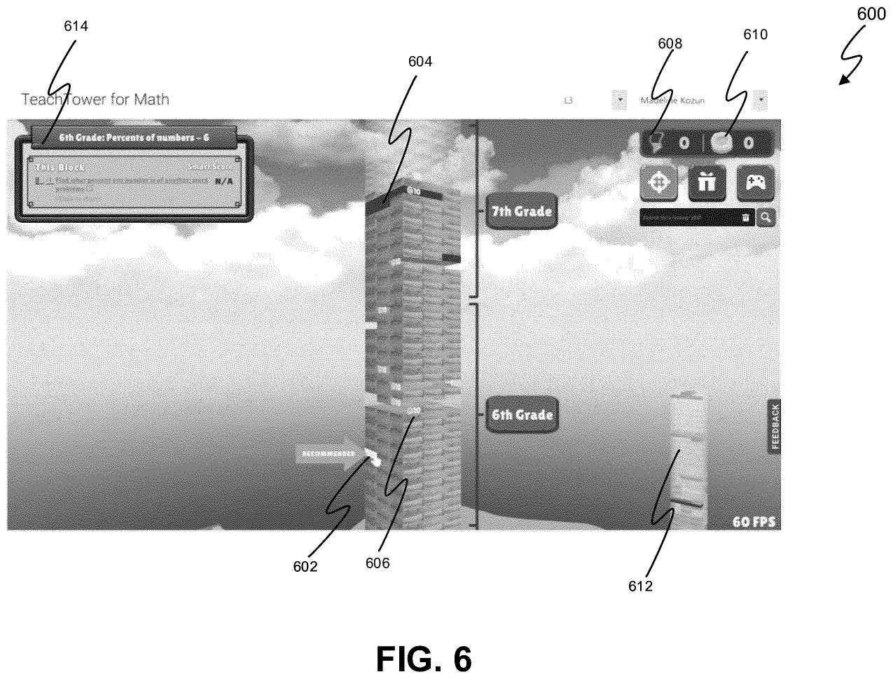

FIGS. 6-8 depict exemplary views of respective user interfaces 600, 700 and 800 of the hierarchical knowledge foundation, visualization, and tracking system 104. Referring to FIG. 6, an exemplary user interface 600 shows user's 102 current mastery level on various concepts related to grade 6 and grade 7. As shown, the user 102 progressed to grade 7, however, the user 102 had gaps in his 6th grade as depicted by a transparent block 602. Typically, the hierarchical knowledge foundation, visualization, and tracking system 104 recommends the user 102 to complete the transparent block 602 left in the 6th grade. Moreover, the knowledge structure 112 of the user also depicts red colored blocks 604 depicting that the user 102 is working or worked on the educational concept in the past on the corresponding educational concept associated with the red colored block 604. Furthermore, the knowledge structure 112 also displays reward 606 corresponding to the blocks suggesting the user can earn rewards after mastering the suggested concept associated with these blocks. Also, the user interfaces 600 shows energy tab 608, reward tab 610. Moreover, the user interface 600 also displays a peer's knowledge tower 612 to compare his/her knowledge structure 112 against his peer's knowledge tower 612. Furthermore, upon double clicking on the block 602, the user interface 600 displays a first pop up 614 showing details related to the concept 602 that was missed by the user in 6th grade.

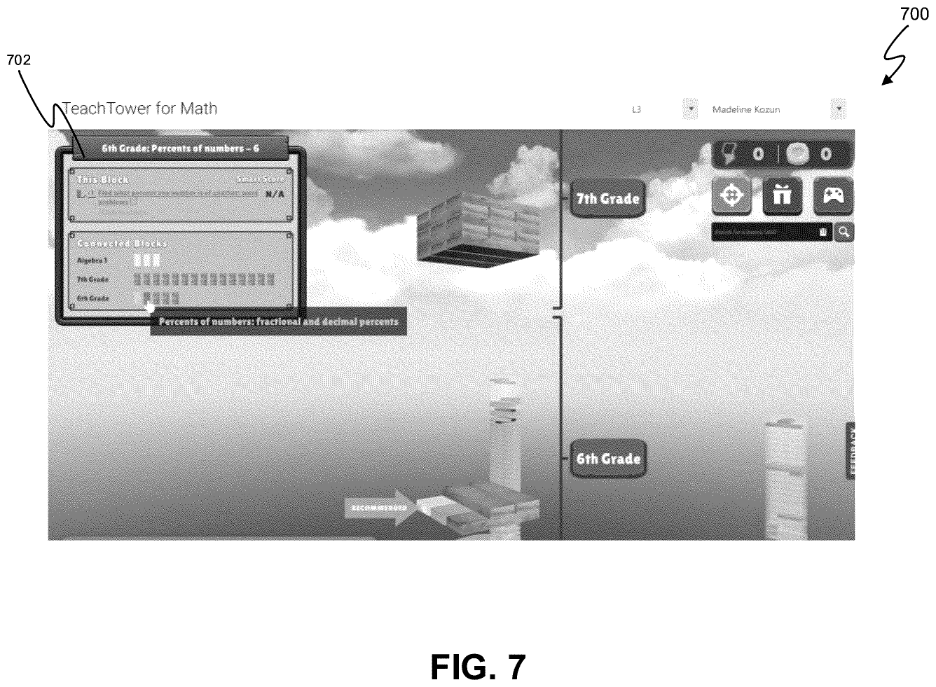

Referring to FIG. 7, depicts an exemplary user interface 700 displayed on display 117 by the hierarchical knowledge foundation, visualization, and tracking system 104 depicts a block from 6th grade including concepts that are prerequisite for 7th grade. The user interface 700 for example, shows a fundamental 6th-grade educational concept like “multiplication and division of fractions” that serves as a foundational building block for 7th grade concepts such as “ratios and proportions” and “decimals and percentages.” Additionally, the 6th-grade educational concept connects to the 7th-grade educational concepts like “solving equations with fractions” and “geometry involving fractional dimensions”. By using the user interface 700, the user can clearly see how mastering one educational concept is crucial for understanding and progressing to multiple subsequent concepts, emphasizing the importance of a strong foundation in earlier topics to support future learning. This visualization aids in planning educational strategies, ensuring that the user 102 acquires the necessary educational concepts and knowledge in a logical and sequential manner. Moreover, the user interface 700 displays a second pop up 702 showing 6th grade connected blocks representing concepts to be completed by the student to build the strong knowledge structure 112 (i.e. tower in this case).

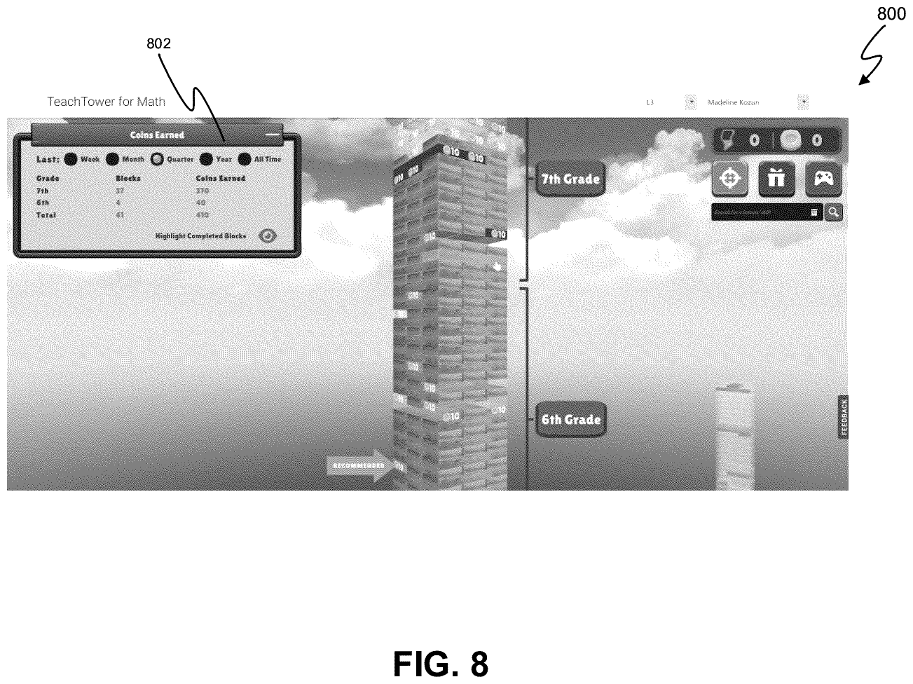

Referring to FIG. 8, an exemplary user interface 800 for the electronic display 117 (FIG. 1) by hierarchical knowledge foundation, visualization, and tracking system 104 depicts how the blocks without gaps stack up to build a strong knowledge structure 112. As discussed in FIG. 1, each knowledge level object representation 110 symbolizes an individual educational concept that the user 102 must master. When the user 102 understands and masters the educational concepts without any gaps in their knowledge structure 112, they effectively stack up the blocks to build a stable knowledge structure 112, representing a robust and comprehensive understanding of the subject matter. Typically, the user 102 needs to master each educational concept thoroughly to ensure a solid knowledge structure 112. Moreover, the gamified element where each knowledge level object representation 110 is used to earn coins over completion of educational concepts. The coins can serve as a form of virtual currency or points within the hierarchical knowledge foundation, visualization, and tracking system 104, to incentivize the user 102 to engage deeply with the educational concepts. Here, the user interface 800 displays a third pop up 802 showing the coins earned by the user 102 while mastering various concepts from 6th and 7th grades.

Below is a summary of the gamification of learning by hierarchical knowledge foundation, visualization, and tracking system 104 with an example representation displayed on display 117 in FIG. 8:
Introduces a gamified element to the learning process through the knowledge tower.
Motivates students by providing a sense of progression as they master new concepts.
Processing Steps:
   Input(s): Student progress in learning material.
   Source(s) of input(s): Educational platform or LMS.
   Output(s): Learning apps or educational platforms.
   Process of converting the input(s) into output(s):
      Process Background and Setup: The system is configured with gamification elements such as points, levels, and rewards.
      Define Operations used: Progress tracking, gamification mechanics.
      Algorithms used: Translate learning progress into gamified elements, e.g. transitioning states of the objects representation 110.
      Relevant Data Models: Gamification model defines the rules and rewards of the game, e.g. completion of predetermined percentage of prerequisite concepts within a time earns X number of points.
      Variables and Definitions: student Progress (data on student's learning progress), gamification Elements (elements like points and levels).
      Constraints: Balancing motivational aspects with educational goals.
      Settings: Gamification settings, reward thresholds.

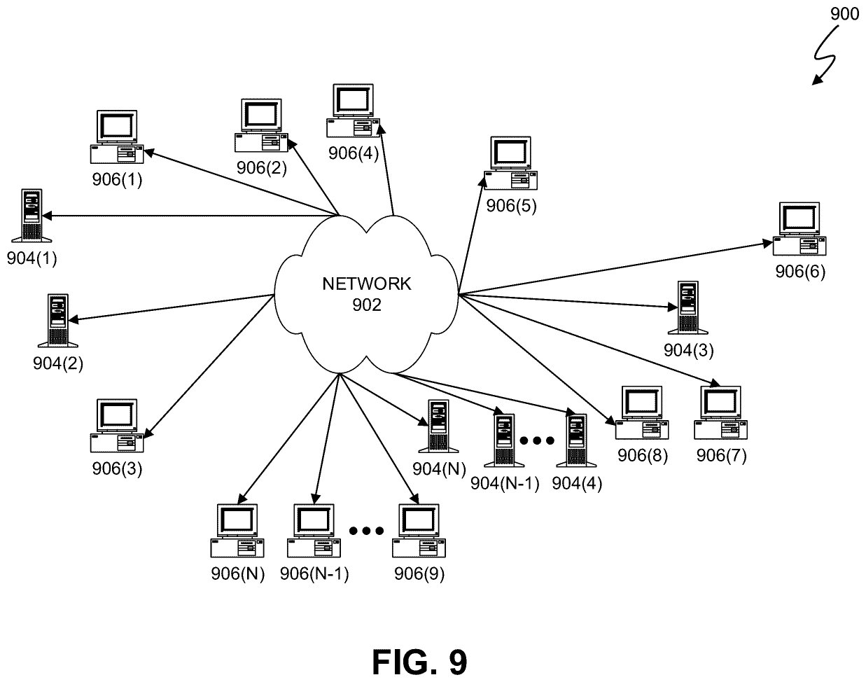

FIG. 9 is a block diagram illustrating a network environment in which a hierarchical knowledge foundation, visualization, and tracking system environment 100 and hierarchical knowledge foundation, visualization, and tracking system environment process 200 may be practiced. Network 902 (e.g. a private wide area network (WAN) or the Internet) includes a number of networked server computer systems 904(1)-(N) that are accessible by client computer systems 906(1)-(N), where N is the number of server computer systems connected to the network. Communication between client computer systems 906(1)-(N) and server computer systems 904(1)-(N) typically occurs over a network, such as a public switched telephone network over asynchronous digital subscriber line (ADSL) telephone lines or high-bandwidth trunks, for example communications channels providing T1 or OC3 service. Client computer systems 906(1)-(N) typically access server computer systems 904(1)-(N) through a service provider, such as an internet service provider (“ISP”) by executing application specific software, commonly referred to as a browser, on one of client computer systems 906(1)-(N).

Client computer systems 906(1)-(N) and/or server computer systems 904(1)-(N) are specialized computer programmed to improve conventional computer systems to implement and utilize the hierarchical knowledge foundation, visualization, and tracking system environment 100 and hierarchical knowledge foundation, visualization, and tracking system environment process 200. The type of computer system that can be specially programmed to implement and utilize the hierarchical knowledge foundation, visualization, and tracking system environment 100 and hierarchical knowledge foundation, visualization, and tracking system environment process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the hierarchical knowledge foundation, visualization, and tracking system environment 100 and hierarchical knowledge foundation, visualization, and tracking system environment process 200 can be implemented using code stored in a tangible, non-transient computer readable medium and executed by one or more processors. In at least one embodiment, the hierarchical knowledge foundation, visualization, and tracking system environment 100 and hierarchical knowledge foundation, visualization, and tracking system environment process 200 can be implemented completely in hardware using, for example, logic circuits and other circuits including field programmable gate arrays.

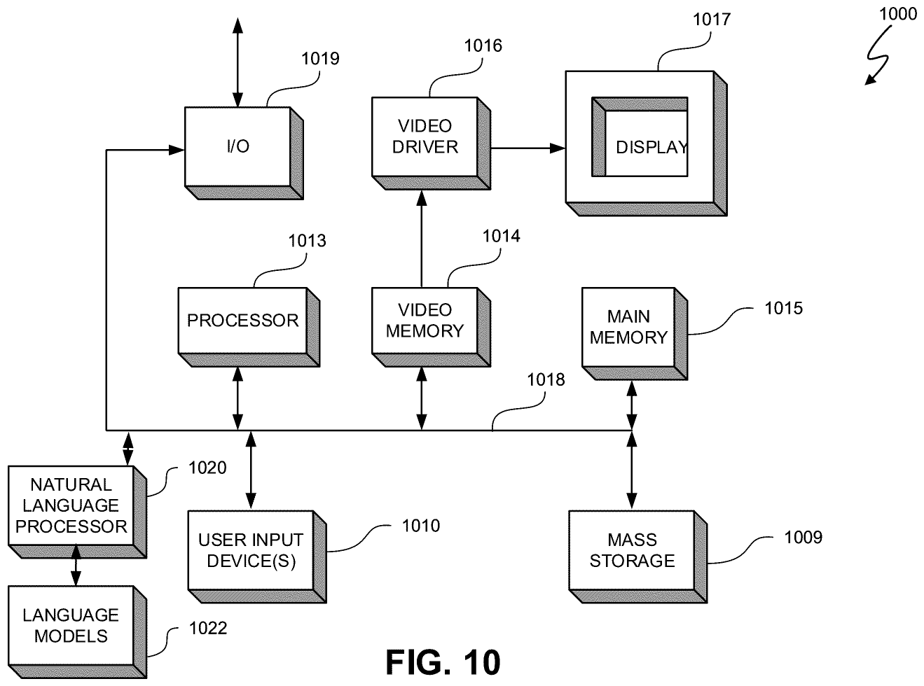

Embodiments of the hierarchical knowledge foundation, visualization, and tracking system environment 100 and hierarchical knowledge foundation, visualization, and tracking system environment process 200 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include both fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU 1009, main memory 1015, video memory 1014 and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer systems via a telephone link or to the Internet via an ISP. I/O device(s) 1019 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1009, into main memory 1015 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the display 1017. Video amplifier 1016 is well known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The hierarchical knowledge foundation, visualization, and tracking system environment 100 and hierarchical knowledge foundation, visualization, and tracking system environment process 200 may be implemented in any type of computer system or programming or processing environment. It is contemplated that the hierarchical knowledge foundation, visualization, and tracking system environment 100 and hierarchical knowledge foundation, visualization, and tracking system environment process 200 might be run on a stand-alone computer system, such as the one described above. The hierarchical knowledge foundation, visualization, and tracking system environment 100 and hierarchical knowledge foundation, visualization, and tracking system environment process 200 might also be run from a server computer systems system that can be accessed by a plurality of client computer systems interconnected over an intranet network. Finally, the hierarchical knowledge foundation, visualization, and tracking system environment 100 and hierarchical knowledge foundation, visualization, and tracking system environment process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for transforming a computer display into a dynamic knowledge structure representing hierarchical knowledge levels, achievements, and prerequisites that represent foundational knowledge to mastery of a knowledge concept, the method comprising:
executing code to cause a computer system to perform operations comprising:
accessing knowledge data that defines knowledge levels, wherein the knowledge levels represent a sequence of knowledge levels to reach mastery levels;
transforming an electronic display to visually present the knowledge levels as interconnected, physical object representations, wherein the interconnections represent the prerequisite knowledge levels;
accessing personnel knowledge completion levels of a student; and
causing appearances of the knowledge level physical objects representation that correspond to respective knowledge levels to be differentiated based on a state of mastery of corresponding knowledge levels by the student that inform the student of progress towards knowledge concept mastery and gaps in the foundational knowledge of the student of the knowledge concept mastery.

2. The method of claim 1 wherein transforming the display to visually present the knowledge levels as interconnected, physical objects comprises:
transforming the display to visually present the knowledge levels as interconnected, 3-dimensional blocks in a tower of blocks, wherein each block that is positioned lower than a higher block is a prerequisite to the higher block.

3. The method of claim 1 wherein causing appearances of the knowledge level physical objects that correspond to respective knowledge levels to be differentiated based on a state of mastery of corresponding knowledge levels by the student comprises:
causing the appearances of the knowledge level physical objects corresponding to a state of non-mastered knowledge levels to be transparent; and
causing the appearances of the knowledge level physical objects corresponding to a state of mastered knowledge levels to be solid.

4. The method of claim 1 wherein causing appearances of the knowledge level physical objects that correspond to respective knowledge levels to be differentiated based on the state of mastery of corresponding knowledge levels by the student comprises:
causing the appearances of the knowledge level physical objects to increase in opacity as the student makes progress towards obtaining master of the knowledge level of the corresponding physical objects.

5. The method of claim 1 wherein accessing knowledge data that defines knowledge levels comprises:
accessing educational, common core curriculum data knowledge data that defines knowledge levels for knowledge topics by student grade level.

6. The method of claim 1 further comprising
executing the code to cause a computer system to perform further operations comprising:
guiding and constraining an Artificial Intelligence (AI) engine to generate an output that transforms the computer display into a dynamic and representation of hierarchical knowledge achievements and prerequisites that represent foundational knowledge to mastery of the, wherein guiding and constraining the AI engine comprises:
generating a prompt; and
providing the prompt to the AI engine, wherein the prompt:
constrains an output of the AI engine to the knowledge data that defines the knowledge levels; and
guides the AI engine to:
access the knowledge data that defines knowledge levels, wherein the knowledge levels represent a sequence of knowledge levels to reach mastery levels;
transform the electronic display to visually present the knowledge levels as interconnected, physical object representations, wherein the interconnections represent the prerequisite knowledge levels;
access the personnel knowledge completion levels of a student; and
cause the appearances of the knowledge level physical objects that correspond to respective knowledge levels to be differentiated based on a state of mastery of corresponding knowledge levels by the student that inform the student of progress towards knowledge concept mastery and gaps in the foundational knowledge of the student of the knowledge concept mastery.

7. The method of claim 1, wherein for each physical object representation, the mastery level of each knowledge concept is represented as learned, learning and unknown state such that ‘learned state’ represents successful completion of resources required to master the corresponding educational concept, ‘learning state’ represents that the user is currently pursuing the resources and yet to master the educational concept, and the ‘unknown state’ represents that status of mastery for a corresponding educational concept is unknown.

8. The method of claim 1 wherein causing appearances of the knowledge level physical objects that correspond to respective knowledge levels to be differentiated based on a state of mastery of corresponding knowledge levels by the student comprises:
causing the appearances of the knowledge level physical objects corresponding to an unknown state of knowledge levels mastery to be transparent;
causing the appearances of the knowledge level physical objects corresponding to a state of non-mastered knowledge levels to be colored; and
causing the appearances of the knowledge level physical objects corresponding to a mastered knowledge level state to have a unique appearance.

9. The method of claim 1 for guiding an Artificial Intelligence (AI) engine to use mastery level of a user on various educational concepts for building a knowledge structure further comprising:
assessing the completion of resources related to individual educational concept and accordingly adjusting the mastery of the user on that concept in the knowledge graph; and
changing state of the individual block representing the corresponding educational concept in the knowledge structure to represent the mastery level of the user on that concept.

10. The method of claim 1 further comprising:
associating rewards with one or more physical object representations to encourage the user to attain mastery on the associated educational concepts.

11. The method of claim 1, wherein each physical object representation is selectable, the method further comprising:
receiving a selection of the physical object representation on the block shows the associated educational concept that needs to be successfully completed to change a state of the block, wherein clicking the block also provides link to one or more resources to be completed by the user to attain mastery in the associated educational concept.

12. The method of claim 1, wherein the knowledge level can be represented as a tower, a pyramid, or any suitable structure where blocks are aligned to show the inter-dependency of concepts.

13. The method of claim 1 further comprising:
guiding an Artificial Intelligence (AI) engine to use mastery level of a user on various educational concepts for building a knowledge structure comprising:
generating a prompt to guide an artificial (AI) engine to render the electronic display to visually present the knowledge levels to reflect the mastery level of the user on various educational concepts; and
transferring the prompt to the AI engine to build the knowledge structure based on the mastery level of the user on various educational concepts.

14. A system for transforming a computer display into a dynamic knowledge structure representing hierarchical knowledge levels, achievements, and prerequisites that represent foundational knowledge to mastery of a knowledge concept, the system comprising:
one or more processors; and
a memory, coupled to the one or more processors, having code stored therein that when executed by the one or more processors causes the one or more processors to perform operations comprising:
accessing knowledge data that defines knowledge levels, wherein the knowledge levels represent a sequence of knowledge levels to reach mastery levels;
transforming an electronic display to visually present the knowledge levels as interconnected, physical object representations, wherein the interconnections represent the prerequisite knowledge levels;
accessing personnel knowledge completion levels of a student; and
causing appearances of the knowledge level physical objects representation that correspond to respective knowledge levels to be differentiated based on a state of mastery of corresponding knowledge levels by the student that inform the student of progress towards knowledge concept mastery and gaps in the foundational knowledge of the student of the knowledge concept mastery.

15. The system of claim 14 wherein transforming the display to visually present the knowledge levels as interconnected, physical objects comprises:
transforming the display to visually present the knowledge levels as interconnected, 3-dimensional blocks in a tower of blocks, wherein each block that is positioned lower than a higher block is a prerequisite to the higher block.

16. The system of claim 14 wherein causing appearances of the knowledge level physical objects that correspond to respective knowledge levels to be differentiated based on a state of mastery of corresponding knowledge levels by the student comprises:
causing the appearances of the knowledge level physical objects corresponding to a state of non-mastered knowledge levels to be transparent; and
causing the appearances of the knowledge level physical objects corresponding to a state of mastered knowledge levels to be solid.

17. The system of claim 14 wherein causing appearances of the knowledge level physical objects that correspond to respective knowledge levels to be differentiated based on the state of mastery of corresponding knowledge levels by the student comprises:
causing the appearances of the knowledge level physical objects to increase in opacity as the student makes progress towards obtaining master of the knowledge level of the corresponding physical objects.

18. The system of claim 14 wherein accessing knowledge data that defines knowledge levels comprises:
accessing educational, common core curriculum data knowledge data that defines knowledge levels for knowledge topics by student grade level.

19. The system of claim 14 further comprising
executing the code to cause a computer system to perform further operations comprising:
guiding and constraining an Artificial Intelligence (AI) engine to generate an output that transforms the computer display into a dynamic and representation of hierarchical knowledge achievements and prerequisites that represent foundational knowledge to mastery of the, wherein guiding and constraining the AI engine comprises:
generating a prompt; and
providing the prompt to the AI engine, wherein the prompt:
constrains an output of the AI engine to the knowledge data that defines the knowledge levels; and
guides the AI engine to:
access the knowledge data that defines knowledge levels, wherein the knowledge levels represent a sequence of knowledge levels to reach mastery levels;
transform the electronic display to visually present the knowledge levels as interconnected, physical object representations, wherein the interconnections represent the prerequisite knowledge levels;
access the personnel knowledge completion levels of a student; and
cause the appearances of the knowledge level physical objects that correspond to respective knowledge levels to be differentiated based on a state of mastery of corresponding knowledge levels by the student that inform the student of progress towards knowledge concept mastery and gaps in the foundational knowledge of the student of the knowledge concept mastery.

20. The system of claim 14, wherein for each physical object representation, the mastery level of each knowledge concept is represented as learned, learning and unknown state such that ‘learned state’ represents successful completion of resources required to master the corresponding educational concept, ‘learning state’ represents that the user is currently pursuing the resources and yet to master the educational concept, and the ‘unknown state’ represents that status of mastery for a corresponding educational concept is unknown.

21. The system of claim 14 wherein causing appearances of the knowledge level physical objects that correspond to respective knowledge levels to be differentiated based on a state of mastery of corresponding knowledge levels by the student comprises:
causing the appearances of the knowledge level physical objects corresponding to an unknown state of knowledge levels mastery to be transparent;
causing the appearances of the knowledge level physical objects corresponding to a state of non-mastered knowledge levels to be colored; and
causing the appearances of the knowledge level physical objects corresponding to a mastered knowledge level state to have a unique appearance.

22. The system of claim 14 for guiding an Artificial Intelligence (AI) engine to use mastery level of a user on various educational concepts for building a knowledge structure further comprising:
assessing the completion of resources related to individual educational concept and accordingly adjusting the mastery of the user on that concept in the knowledge graph; and
changing state of the individual block representing the corresponding educational concept in the knowledge structure to represent the mastery level of the user on that concept.

23. The system of claim 14 wherein execution of the code by the one or more processors causes the one or more processors to perform operations further comprising:
associating rewards with one or more physical object representations to encourage the user to attain mastery on the associated educational concepts.

24. The system of claim 14, wherein each physical object representation is selectable, the system further comprising:
receiving a selection of the physical object representation on the block shows the associated educational concept that needs to be successfully completed to change a state of the block, wherein clicking the block also provides link to one or more resources to be completed by the user to attain mastery in the associated educational concept.

25. The system of claim 14, wherein the knowledge level can be represented as a tower, a pyramid, or any suitable structure where blocks are aligned to show the inter-dependency of concepts.

26. The system of claim 14 wherein execution of the code by the one or more processors causes the one or more processors to perform operations further comprising:
guiding an Artificial Intelligence (AI) engine to use mastery level of a user on various educational concepts for building a knowledge structure comprising:
generating a prompt to guide an artificial (AI) engine to render the electronic display to visually present the knowledge levels to reflect the mastery level of the user on various educational concepts; and
transferring the prompt to the AI engine to build the knowledge structure based on the mastery level of the user on various educational concepts.
